(19) United States
(12) Patent Application Publication
(10) Pub. No.: US 2018/0234754 A1
(43) Pub. Date: Aug. 16, 2018

(54) Reproduction of Ambient Environmental Sound for Acoustic Transparency of Ear Canal Device System and Method

(71) Applicant: BRAGI GmbH, München (DE)

(72) Inventor: Nikolaj Hviid, München (DE)

(73) Assignee: BRAGI GmbH, München (DE)

(21) Appl. No.: 15/940,607

(22) Filed: Mar. 29, 2018

Related U.S. Application Data
(63) Continuation of application No. 15/244,958, filed on Aug. 23, 2016, now Pat. No. 9,949,008.
(60) Provisional application No. 62/211,732, filed on Aug. 29, 2015.

(51) Int. Cl. H04R 1/10

(52) U.S. Cl. CPC H04R 1/1016; H04R 2460/05; H04R 1/1091; H04R 1/1075

(57) ABSTRACT

An ear piece for use by an individual having an external auditory canal includes an earpiece housing configured for placement within the external auditory canal of the individual, a processor disposed within the ear piece housing, at least one microphone disposed within the earpiece housing wherein the at least one earpiece is positioned to detect ambient environmental sound, and at least one speaker disposed within the earpiece housing. The ear piece is configured to detect ambient environmental sound proximate the external auditory canal of the individual using the at least one microphone and reproduce the ambient environmental sound at the at least one speaker within the earpiece housing. The processor is further configured to modify the ambient environmental sound based on shape of the external auditory canal such that audio perception of the ambient environmental sound is as if the ear piece was not present.

### PRIORITY STATEMENT

This application claims priority to U.S. Provisional Patent Application No. 62/211,732, filed Aug. 29, 2015, and is a continuation application of U.S. patent application Ser. No. 15/244,958, filed Aug. 23, 2016 both applications are hereby incorporated by reference in their entirety.

### FIELD OF THE INVENTION

The present invention relates to wearable devices. More particularly, but not exclusively, the present invention relates to ear canal devices.

### BACKGROUND OF THE ART

The use of ear canal devices is becoming increasingly prevalent. Ear canal devices are gaining recognition for their ability to provide a stable platform for the transmission of sound to the individual from many types of linked devices including, without limitation, phones, portable music players, watches and computers among others. Further, the ear canal has been recognized as a rich area for the monitoring of many biometric parameters. Pulse oximetry, temperature, heart rate, speed and pace are several examples of data that can be tracked or monitored from ear canal devices.

Additionally, they have the advantage of relatively stable positioning on the user, and are subject to less movement variation than sensor arrays that would be worn elsewhere, such as on the wrist. However, the use of these devices can become problematic for the user, as they can cause a decrease in auditory acuity due to their position at the ear canal. Thus, there is a need to restore auditory transparency when using ear canal devices.

### SUMMARY

Therefore, it is a primary object, feature, or advantage to improve over the state of the art. It is a further object, feature, or advantage to restore audio transparency when using ear canal devices.

A still further object, feature, or advantage of the present invention is to provide for the ability to use external microphone or microphones to detect ambient environmental sound.

Another object, feature, or advantage of the present invention is to account for the sound shaping characteristics of the external auditory canal.

Yet another object, feature, or advantage of the present invention is to present the signal through the microphone located in the external auditory canal nearest the tympanic membrane to allow the user to perceive acoustic stimuli in such a fashion that the device is acoustically transparent

Another object, feature, or advantage is to avoid the need to accept diminished auditory inputs at the level of the external auditory canal.

One or more of these and/or other objects, features, or advantages of the present invention will become apparent from the specification and claims that follow. No single embodiment need exhibit each and every object, feature, or advantage. It is contemplated that different embodiments may have different objects, features, or advantages.

According to one aspect, an ear piece for use by an individual having an external auditory canal is provided. The earpiece includes an earpiece housing configured for placement within the external auditory canal of the individual, a processor disposed within the ear piece housing, at least one microphone disposed within the earpiece housing wherein the at least one earpiece is positioned to detect ambient environmental sound, and at least one speaker disposed within the earpiece housing. The ear piece is configured to detect ambient environmental sound proximate the external auditory canal of the individual using the at least one microphone and reproduce the ambient environmental sound at the at least one speaker within the earpiece housing. The processor may be further configured to modify the ambient environmental sound based on shape of the external auditory canal such that audio perception of the ambient environmental sound is as if the ear piece was not present. The ear piece housing may be water resistant. The at least one speaker may be positioned at the external auditory canal proximate a tympanic membrane of the individual. The ear piece may further include at least one biological sensor operatively connected to the processor. The at least one biological sensor may include a pulse oximeter and/or temperature sensor.

According to another aspect, a method for an ear canal device is provided. The method includes providing an ear piece for use by an individual having an external auditory canal, the ear piece comprising an earpiece housing configured for placement within the external auditory canal of the individual, a processor disposed within the ear piece housing, at least one microphone disposed within the earpiece housing wherein the at least one earpiece is positioned to detect ambient environmental sound, and at least one speaker disposed within the earpiece housing. The method may further include detecting ambient environmental sound proximate the external auditory canal of the individual using the at least one microphone and reproducing at the ambient environmental sound at the at least one speaker within the earpiece housing to thereby provide for audio transparency. The method may further include modifying the ambient environmental sound based on shape of the external audio canal of the individual. The reproducing may occur at the speaker nearest a tympanic membrane of the individual. The ear piece may further include a biological sensor and the method may further provide for sensing a biological parameter using the biological sensor. The biological sensor may be a pulse oximeter, temperature sensor, or other type of biological sensor.

### BRIEF DESCRIPTION OF THE DRAWINGS

FIG. 1 illustrates one example of a wearable device in the form of a set of earpieces.

FIG. 2 illustrates one example of an ear piece positioned within an external auditory canal of an individual.

FIG. 3 is a block diagram illustrating one example of a device.

FIG. 4 illustrates one example of a method.

### DETAILED DESCRIPTION

To restore auditory transparency when using ear canal devices through the use of at least one external facing microphone to detect incoming auditory stimuli. Said incoming auditory signal can be shaped to account for the characteristics of each user's external auditory canal. Sound would then be presented to the tympanic membrane via a speaker present in the user's external auditory canal. This renders the ear canal device acoustically transparent. The user's hearing is unaffected, and auditory perception is as if the device wasn't physically present at the ear canal.

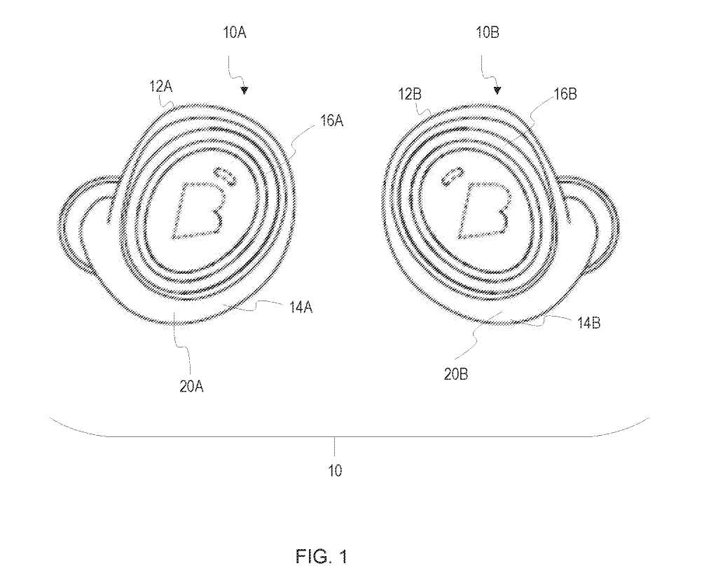

FIG. 1 illustrates one example of a wearable device in the form of a set of earpieces 10 including a left ear piece 12A and a right earpiece 12B. Each of the ear pieces 12A, 12B has a housing 14A, 14B which may be in the form of a protective shell or casing and may be an in-the-ear earpiece housing. Note that when each of the earpieces 12A, 12B is placed within a corresponding external auditory canal the external auditory canal of the user would be physically blocked and not open. Thus, the user would not conventionally be able to hear ambient noise. Although perhaps appropriate for use in a hearing aid, this blocking of ambient environmental sound is problematic.

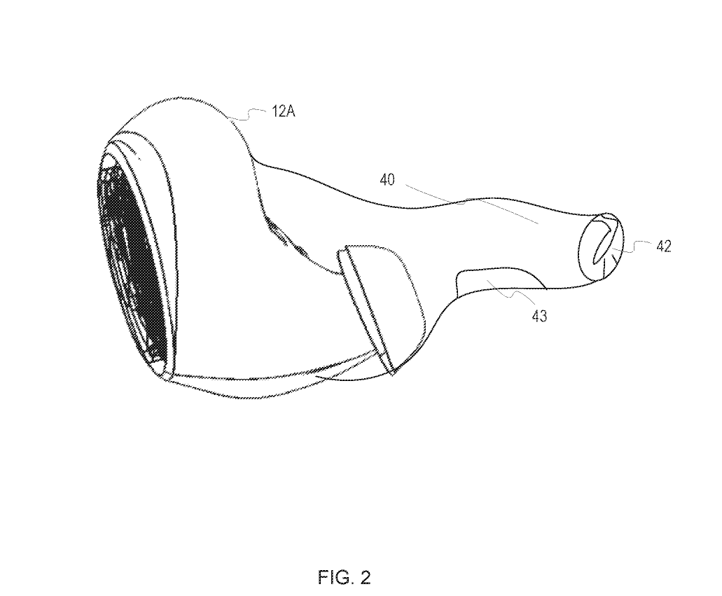

FIG. 2 illustrates an ear piece 12A inserted into an ear of an individual or user. The ear piece 12A fits at least partially into the external auditory canal 40 of the individual. A tympanic membrane 42 is shown at the end of the external auditory canal 40. The earpiece 12A has a sleeve 13A on the earpiece. The sleeve may be formed of silicone or other material which is safe for an individual to wear and which improves comfort for the user. The sleeve may be in any number of sizes including, extra small, small, medium, and large.

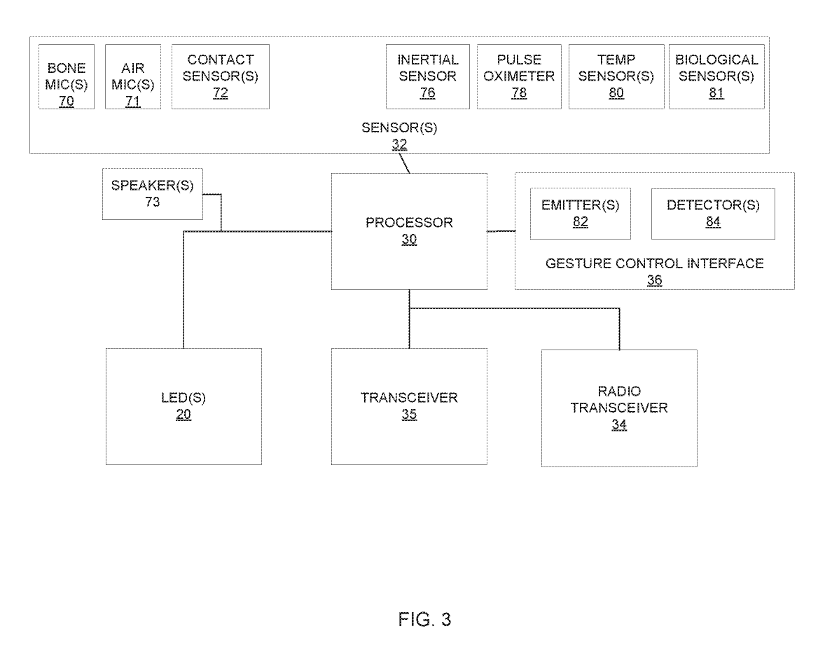

FIG. 3 is a block diagram illustrating a device. The device may include one or more LEDs 20 electrically connected to a processor 30. The processor 30 may also be electrically connected to one or more sensors 32. Where the device is an earpiece, the sensor(s) may include an inertial sensor 76, an accelerometer 74, one or more contact sensors 72, a bone conduction microphone or air conduction microphone 70, a pulse oximeter 76, a temperature sensor 80, or other biological sensors. A gesture control interface 36 is also operatively connected to the process 30. The gesture control interface 36 may include one or more emitters 82 and one or more detectors 84 for sensing user gestures. The emitters may be of any number of types including infrared LEDs. The device may include a transceiver 35 which may allow for induction transmissions such as through near field magnetic induction. A short range transceiver 34 using Bluetooth, UWB, or other means of radio communication may also be present. In operation, the processor 30 may be programmed to convey different information using one or more of the LED(s) 20 based on context or mode of operation of the device. The various sensors 32, the processor 30, and other electronic components may be located on the printed circuit board of the device.

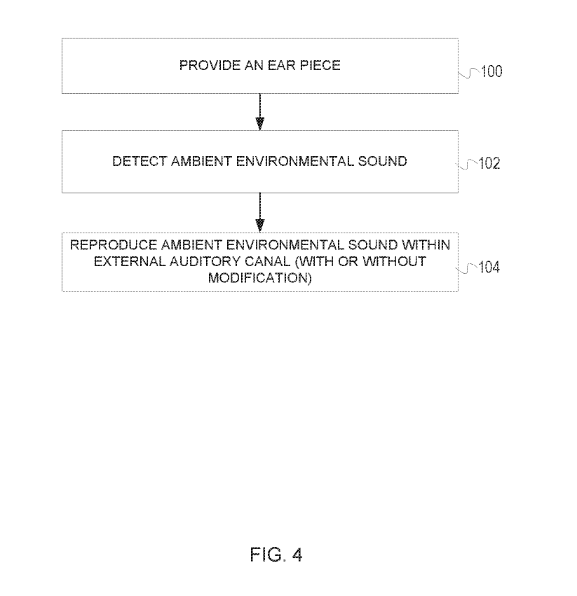

FIG. 4 illustrates one example of a method. As shown in FIG. 4, in step 100 an ear piece is produced. In step 102, the ambient environmental sound is detected. In step 104, the ambient environmental sound is reproduced within the external auditory canal with or without modification. Where the ambient environmental sound is reproduced with modification, the modification may take into account the size and shape of the external auditory canal of the individual in order to modify any received signal in a manner to best approximate or reproduce the sound as if heard directly by the user as opposed to having the sound sensed on one side of the ear piece (the external side) and reproduced at the other side of the ear piece (the inner side nearest the tympanic membrane). The sound processing performed by the ear piece may further take into consideration position of one or more microphones of the external earpiece as well.

Generally, the ear canal is about 2.5 cm (1 in) long and 0.7 cm (0.28 in) in diameter with a sigmoid form and runs from behind and above downward and forward. It has a generally oval cross-section. The size and shape of an external auditory canal of a user may be determined in any number of different ways. For example, sound signals may be emitted by a speaker and reflections of those sound signals may be detected by one or more microphones in order to map the size and shape of the external auditory canal such as by using shifts in frequency or delays. The size and shape of the external auditory canal may also be determined at least in part based on the size of the best fitting earpiece or an associated sleeve which fits around the earpiece. The size and shape of the external auditory canal may be also be determined based on direct measurement, photogrammetry, or other observation. In addition, the user may select different sizes and shapes for their external auditory canal. For example, the earpiece may cycle through a plurality of different size settings and modify a sound differently at each setting. The user may then select through voice command or through the user interface whether the setting or settings produce a better or worse reproduction of the sound in order to select the appropriate settings. The ambient environmental sounds themselves may be modified in various ways based on the different external auditory canal sizes and shapes. For example, one or more sound filters may be associated with each setting or combination of settings. Alternatively, settings regarding ear canal size and shape may be used to parameterize other sound processing algorithms used in reproduction of the environmental sound.

Therefore, various examples of systems, devices, apparatus, and methods for restoring auditory transparency when using ear canal devices through the use of at least one external facing microphone to detect incoming auditory stimuli have been shown and described. Although various embodiments and examples have been set forth, the present invention contemplates numerous variations, options, and alternatives.

What is claimed is:

1. An earpiece for use by an individual having an external auditory canal, comprising:
an earpiece housing configured for placement within the external auditory canal of the individual;
a processor disposed within the earpiece housing;
at least one transceiver operatively connected to the processor;
at least one microphone disposed within the earpiece housing and operatively connected to the processor wherein the at least microphone is positioned to detect ambient environmental sound;
at least one speaker disposed within the earpiece housing and operatively connected to the processor; wherein the speaker is configured to reproduce the ambient environmental sound;
wherein the processor is further configured to determine the size and shape of the external auditory canal; and
wherein the processor is further configured to modify the ambient environmental sound based on the size and shape of the external auditory canal.

2. The earpiece of claim 1 wherein the shape of the external auditory canal is determined at least in part based on a size of a sleeve for the earpiece.

3. The earpiece of claim 1 wherein the shape of the external auditory canal is determined by a user setting.

4. The ear piece of claim 1 wherein the earpiece housing is water resistant.

5. The ear piece of claim 1 wherein the at least one speaker is positioned at the external auditory canal proximate a tympanic membrane of the individual.

6. The ear piece of claim 1 wherein the at least one speaker and at least one microphone are used to map the size and shape of the external auditory canal.

7. The ear piece of claim 1 wherein the earpiece further comprises a gestural interface.

8. The ear piece of claim 1 wherein the processor is configured to apply sound filters associated with size and shape of the external auditory canal.

9. The ear piece of claim 1 wherein the at least one microphone comprises a plurality of microphones.

10. A method for an ear canal device, the method comprising:
providing an ear piece for use by an individual having an external auditory canal, the ear piece comprising an earpiece housing configured for placement within the external auditory canal of the individual, a processor disposed within the ear piece housing, a user interface operatively connected to the processor, at least one microphone disposed within the earpiece housing wherein the at least one earpiece is positioned to detect ambient environmental sound, and at least one speaker disposed within the earpiece housing;
detecting ambient environmental sound proximate the external auditory canal of the individual using the at least one microphone;
determining the size or shape of the external auditory canal;
modifying the ambient environmental sound based on shape of the external audio canal of the individual; and
reproducing at the ambient environmental sound at the at least one speaker within the earpiece housing to thereby provide for audio transparency.

11. The method of claim 10 wherein the reproducing occurs at one of the at least one speaker nearest a tympanic membrane of the individual.

12. The method of claim 10 wherein the ear piece further comprises a biological sensor and further comprising sensing a biological parameter using the biological sensor.

13. The method of claim 10 wherein the user interface comprises a gestural interface.

14. The method of claim 10 wherein the at least one speaker and at least one microphone are used to map the size and shape of the external auditory canal.

15. The method of claim 10 wherein the earpiece further comprises at least one LED.

16. The method of claim 17 wherein the process is configured to convey information to the user using the at least one LED.

17. The method of claim 10 wherein the shape of the external auditory canal is determined by a user setting.

18. The method of claim 10 wherein the processor cycles through different size settings and modifies the sound differently at each size setting.

19. The method of claim 19 wherein the user selects the size setting by using a user interface.

20. The method of claim 10 wherein the processor is configured to apply sound filters associated with size and shape of the external auditory canal.
